(19) United States
(12) Patent Application Publication
(10) Pub. No.: US 2015/0306631 A1
(43) Pub. Date: Oct. 29, 2015

(54) WASTE SORTING DEVICE HAVING A ROTARY SCREEN

(71) Applicant: GREEN CREATIVE, Sucy en Brie (FR)

(72) Inventors: Jean-Marc MEURVILLE, Sens (FR); Remi GOMEZ, Paris (FR); Nicolas LAURENT, Tinqueux (FR); Jan-Francois CHAMOUX, Lagny-Sur-Marne (FR); Lucile NOURY-SOYER, Paris (FR)

(21) Appl. No.: 14/443,830

(22) PCT Filed: Nov. 18, 2013
(86) PCT No.: PCT/EP2013/074108

§ 371 Date: May 19, 2015

(30) Foreign Application Priority Data
Nov. 19, 2012 (FR) 12 03093

(51) Int. Cl. B07B 1/24

(52) U.S. Cl. CPC B07B 1/24

(57) ABSTRACT

A processing apparatus for collecting matter adhering to the outside surfaces of packages for processing and that have previously been shredded, includes a rotary cylindrical drum forming a screen for retaining the shredded packages and for allowing the matter for collection to pass through, a rotary brush mounted in the rotary drum in order to brush the inside face of the drum, motor means for driving the brush and the cylindrical drum in rotation, and at outer casing for collecting the matter coming from the shredded packages introduced into the cylindrical drum and that have passed through the wall of the cylindrical drum.

The invention relates to a device for cleaning packages in the context of reprocessing waste coming in particular from retail goods.

### BACKGROUND OF THE INVENTION

In the field of processing waste coming in particular from retail goods, patent document FR 2 943 630 discloses a device for extracting a liquid or pasty substance contained in a container made of non-brittle material, such as a container containing a cosmetic or a tin can.

That device has two wheels rotating about parallel axes and spaced apart from each other by a gap, there being motor means for driving the two wheels in rotation in opposite directions. One of the wheels has spikes projecting radially therefrom and the other wheel has recesses for receiving the spikes when they are level with the gap.

When a package is inserted into that device, it is simultaneously flattened and punctured as it passes through the gap, thereby enabling its content to be extracted in order to separate the packaging from the content that has been extracted therefrom.

Specifically, a package leaving that device, such as for example a can, is in shreds and a portion of the substance initially contained in the package still adheres to the faces of the package, and has not genuinely been extracted.

### OBJECT OF THE INVENTION

The object of the invention is to propose a solution for remedying the above drawbacks.

### SUMMARY OF THE INVENTION

To this end, the invention provides processing apparatus for collecting matter adhering to the outside surfaces of packages for processing and that have previously been shredded, the apparatus comprising:
a rotary cylindrical drum forming a screen for retaining the shredded packages and for allowing the matter for collection to pass through;
a rotary brush mounted in the rotary drum in order to brush the inside face of the drum;
motor means for driving the brush and the cylindrical drum in rotation; and
an outer casing for collecting the matter coming from the shredded packages introduced into the cylindrical drum and that has passed through the wall of the cylindrical drum.

The invention also provides apparatus as defined above, wherein the drum has teeth on its inside face for pushing the packages between the brush and the inside face of the drum.

The invention also provides apparatus as defined above, having a casing surrounding the outside face of the drum in order to collect the matter that has passed through the drum during processing.

The invention also provides apparatus as defined above, wherein the drum is inclined relative to the horizontal in order to facilitate admitting and discharging packages for processing and also discharging extracted matter.

The invention also provides apparatus as defined above, wherein the drum is provided with blades on its outside face that are arranged in a helical configuration to push the extracted matter along the inside face of the casing when the drum rotates.

The invention also provides apparatus as defined above, wherein the brush has brushing elements arranged in a helical pattern in order to facilitate moving shredded packages along the apparatus while they are being processed.

### BRIEF DESCRIPTION OF THE FIGURES

FIG. 1 is an overall view of the apparatus of the invention, shown in perspective:

FIG. 2 is a side view in section of the apparatus of the invention, showing the inside of its drum with the rotary brush; and

FIG. 3 is a side view in section of the apparatus of the invention showing the outside of its drum fitted with fins that are arranged in a helical pattern.

### DETAILED DESCRIPTION OF THE INVENTION

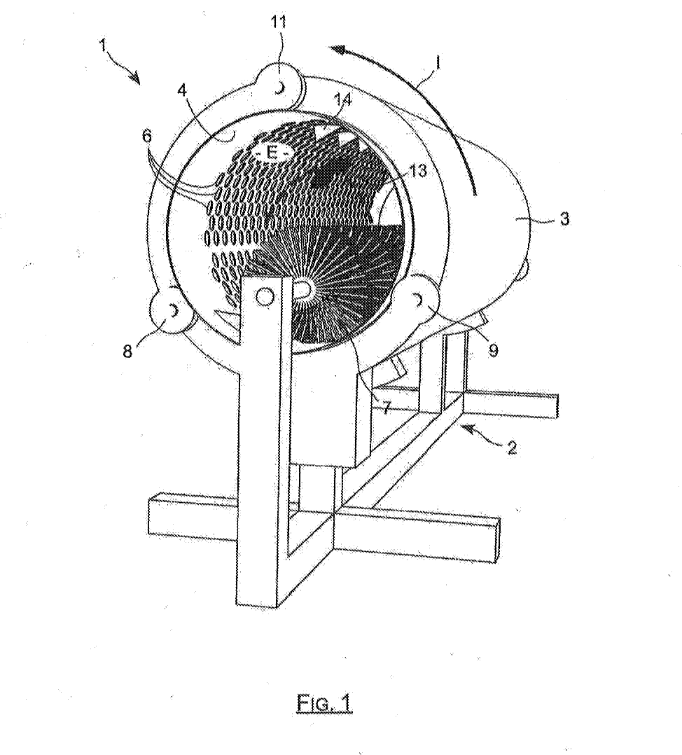

The processor apparatus of the invention given reference 1 in FIG. 1 comprises a stand 2 in the form of a structure made up of machine-welded steel beams carrying a rigid casing 3 in the form of a cylinder of unperforated sheet metal that extends horizontally.

The casing 3 contains a drum or trommel 4 in the form of a sheet metal cylinder that is perforated by a series of holes or openings 6 over the great majority of its area so as to constitute a rotary screen, and a rotary cylindrical brush 7 mounted inside the trommel 4.

As can be seen in FIG. 1, the cylindrical brush 7 has a diameter that is about half the inside diameter of the trommel 4, and the cylindrical casing 3 has a diameter greater than the diameter of the trommel 4 since it surrounds the trammel. Other diameter values could be selected as a function of the general arrangement used.

The trommel 4 is mounted to rotate, being guided at each of its ends by three rotary wheels arranged at one-hundred twenty degrees around its axis of rotation, these wheels being referenced 8, 9, and 11 at the end that is visible in FIG. 1.

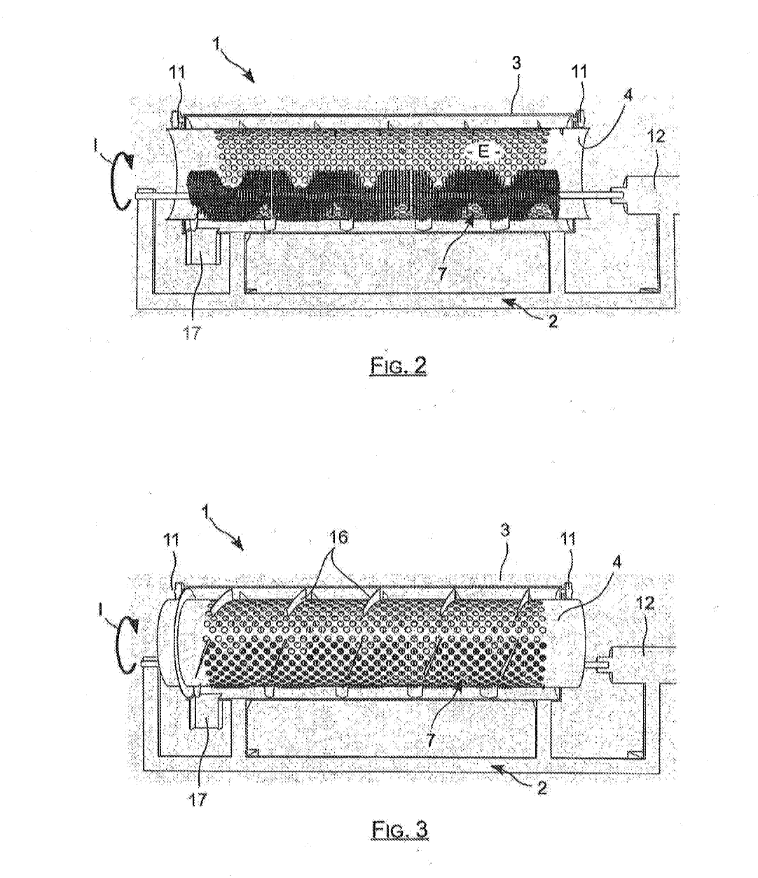

The brush 7 is driven in rotation by a motor 12 (that can be seen in part in FIG. 2), and it is carried by the stand 2, at one of the ends of the apparatus. This brush 7, which is rotated by the motor 12, can itself serve to drive the trammel 4 in rotation. Additional drive means may also be provided for rotating the trammel, in the same direction as the brush 7, and at the slower speed.

In operation, the brush 7 and the trommel 4 both rotate in the same direction, which is the counterclockwise direction identified by the letter I in FIG. 1, thereby having the effect of stirring the packaging for processing present in the inside space F defined by the trommel 7 and the brush 4.

Specifically, each packaging element, such as for example the element referenced 13 in FIG. 1, follows a circular path while it is being processed: it is caught up by the brush 7 so as to be brushed and brought into the gap, i.e. the zone where the brush presses against the inside face 7, where this item is brushed.

This has the effect of removing matter adhering to the surface of this shredded package 13. Once this item has left the gap zone, it is ejected by the brush 7 into the upper region in order to follow a substantially circular path as represented by a dashed-line arrow in FIG. 1, during which it skips on top of the brush 7 prior to being caught up once more by the brush so as to pass through the gap.

While following this path, it also happens frequently that, on dropping, the package lands initially on the brush in such a manner that the brush rolls it against the inside face of the trommel 4, thereby having the effect of further increasing the effectiveness with which matter adhering thereto is removed.

During each cycle of skipping, the package being processed loses an additional portion of the matter adhering to its surface, which matter is brushed away by the brush 7 each time the package passes through the gap, and the matter is also centrifuged when the package passes over the top of the brush while turning.

The dimensions of the openings 6 in the drum 4 are selected so as to retain shredded and lacerated packages, while allowing the matter that the packages used to contain and that was adhering thereto to pass through. Passage of the matter in question is made even easier by the centrifugal effect of the trommel 4 rotating, such that this matter is subsequently to be found in the casing 3, while the shredded packages are retained inside the space E.

In addition, the trammel 4 has various teeth, referenced 14 in FIG. 1, on its inside face, which teeth extend radially so as to interfere with the brushing elements of the brush 7 while the system is in operation. These teeth thus serve to cut up any plastic bags or the like that are to be found in the packaging for sorting, so as to ensure that plastic bags do not disturb the processing process.

As can be seen in FIG. 1, each tooth 14 is plane in shape with a triangular outline, and it extends in a plane normal to the axis of rotation of the trommel, while pointing towards the axis. Furthermore, each tooth 14 has a right front edge, i.e. a front edge that extends radially relative to the axis of rotation, which is the edge that meets the brush first in operation, and a sloping rear edge. The sloping rear edge is the edge of the tooth that loses contact with the brush after passing through the gap.

The rear edges of the teeth 14 facilitate cleaning the apparatus: under such circumstances, the equipment is made to rotate in the direction opposite to its direction of rotation during processing, so that it is the sloping edges of the teeth that interfere with the elements of the brush. This causes the brushing elements to bend considerably during rotation, thereby enhancing effective cleaning of the brush. During this cleaning stage, the sloping edges serve to lacerate any plastic films present among the packages for processing.

As shown in FIG. 2, the brushing elements of the brush 7, i.e. its bristles, are installed all along the brush in a helical pattern so as to drive packages along the trommel 4 while they are being processed, thereby causing them to be discharged naturally from one of the ends of the trommel 4.

In analogous manner, the outside face of the trommel 4 has a set of blades 16 that are also arranged in a helical pattern in order to drive the extracted matter along the casing that contains them so as to enable it to be extracted from one of the ends of the casing 4. In the example shown in the figures, a bottom vertical duct 17 is provided that is connected to a bottom opening in the casing 3 situated at the end of the casing that is remote from the motor 12.

Furthermore, as can be seen in FIGS. 2 and 3, the helices corresponding to the pattern of the rotary brush 7 and to the arrangement of the blades 16 have oppositely-oriented pitches, so that the packages for treatment and the extracted matter are moved, in opposite directions along the apparatus during the processing process.

Specifically, in the arrangement of the figures, when the brush 7 and the trommel 4 are driven in the counterclockwise direction referenced I, the shredded packages for processing are introduced into the space E through its end remote from the motor 12.

During the processing, the packages skip along the top of the brush 7 while being periodically caught by the brush, and they are simultaneously moved progressively towards the end where the motor 12 is located as a result of the generally helical shape of the brush 7. Simultaneously, matter that was initially adhering to the packages is extracted and passes through the screen constituted by the trommel 4 so as to be found in the bottom portion of the casing, where it is conveyed by the blades 16 towards the discharge duct 17 in order of be recovered, e.g. in a container placed under the duct.

Advantageously, the entire device is inclined so that the end remote from the motor 12 through which the packages for processing are inserted is lower than the other end through which the packages that have been treated are removed. This configuration facilitates effective processing in which it is the helical shape of the brush that causes processed packages to move upwards. It is also possible to envisage providing an opposite slope in order to make it easier to discharge packages and to remove the extracted matter.

1. Processing apparatus (1) for collecting matter adhering to the outside surfaces of packages (13) for processing and that have previously been shredded, the apparatus (1) comprising:
a rotary cylindrical drum (4) forming a screen for retaining the shredded packages (13) and for allowing the matter for collection to pass through;
a rotary brush (7) mounted in the rotary drum (4) in order to brush the inside face of the drum;
motor means (12) for driving the brush (7) and the cylindrical drum (4) in rotation;
an outer casing (3) for collecting the matter coming from the shredded packages (13) introduced into the cylindrical drum (4) and that has passed through the wall of the cylindrical drum (4).

2. Apparatus according to claim 1, wherein the drum (4) has teeth (14) on its inside face for pushing the packages (13) between the brush (7) and the inside face of the drum (4).

3. Apparatus according to one of the preceding claims, comprising a casing (3) surrounding the outside face of the drum (4) in order to collect the matter that has passed through the drum (4) during processing.

4. Apparatus according to one of claims 1 to 3, wherein the drum (4) is inclined relative to the horizontal in order to facilitate admitting and discharging packages (13) for processing and also discharging extracted matter.

5. Apparatus according to claim 3, wherein the drum (4) is provided with blades (16) on its outside face that are arranged in a helical configuration to push the extracted matter along the inside face of the casing (3) when the drum (4) rotates.

6. Apparatus according to one of claims 5 to 7, wherein the brush (7) has brushing elements arranged in a helical pattern in order to facilitate moving shredded packages (13) along the apparatus while they are being processed.
